(19) United States
(12) Patent Application Publication
(10) Pub. No.: US 2013/0230711 A1
(43) Pub. Date: Sep. 5, 2013

(54) ABS RESIN COMPOSITION CAPABLE OF MAINTAINING HIGH GLOSSINESS IN THERMOFORMING AND ABS SHEET USING SAME

(71) Applicants: Sang-Won You, Daejeon (KR); Min-Hee Lee, Gunpo-si (KR); Eung-Kee Lee, Gunpo-si (KR); Chang-Hak Shin, Seoul (KR)

(72) Inventors: Sang-Won You, Daejeon (KR); Min-Hee Lee, Gunpo-si (KR); Eung-Kee Lee, Gunpo-si (KR); Chang-Hak Shin, Seoul (KR)

(73) Assignee: LG Hausys, Ltd., Yeongdeungpo-gu, Seoul (KR)

(21) Appl. No.: 13/884,228

(22) PCT Filed: Nov. 7, 2011
(86) PCT No.: PCT/KR2011/008415

§ 371 Date: May 8, 2013

(30) Foreign Application Priority Data
Nov. 8, 2010 (KR) 10-2010-0110212

(51) Int. Cl. C08L 47/00

(52) U.S. Cl. CPC C08L 47/00
USPC 428/220; 525/234; 524/521

(57) ABSTRACT

Disclosed are an ABS resin composition and an ABS sheet using the same, wherein the ABS resin composition has an excellent surface quality and enables the manufacture of a sheet with excellent glossiness even in thermoforming. The ABS resin composition according to the invention comprises a) 50-80 weight % of an acrylonitrile-butadiene-styrene (ABS) resin, b) 10-30 weight % of a styrene-acrylonitrile (SAN) copolymer, and c) 10-20 weight % of a rubber resin, wherein the ABS resin is a bulk polymerization-type ABS resin.

### TECHNICAL FIELD

The present invention relates to a method of manufacturing an acrylonitrile butadiene styrene (ABS) sheet, and more particularly to an ABS resin composition having excellent surface quality as compared with a sheet using a conventional ABS resin, and ensuring superior gloss even in thermoforming, and an ABS sheet using the same.

### BACKGROUND ART

Acrylonitrile butadiene styrene (ABS) resins can be generally classified into bulk polymerized ABS resins, emulsion polymerized ABS resins, and suspension polymerized ABS resins. Among these, the bulk polymerized ABS resins and the emulsion polymerized ABS resins are most commonly used.

ABS resins exhibit different physical properties and characteristics depending on polymerization method.

When a bulk polymerized ABS resin is used to manufacture a glossy sheet, the sheet has excellent surface quality due to a less gel content but becomes a matt sheet after thermoforming at 150 to 200° C.

When an emulsion polymerized ABS resin is used to manufacture a glossy sheet, the sheet exhibits gloss due to small size of rubber particles and particularly maintains glossy properties to a certain degree in thermoforming However, an emulsifying agent and a cohesive agent necessarily used in emulsion polymerization are not completely removed in cohesion and dehydration processes and remain in a final product, thereby deteriorating physical properties while forming a large amount of gel on the surface of the sheet.

Currently, neither the bulk polymerized ABS resin nor the emulsion polymerized ABS resin provide satisfactory surface quality and gloss.

### DISCLOSURE

### Technical Problem

An aspect of the present invention is to provide an acrylonitrile butadiene styrene (ABS) resin composition capable of forming an ABS sheet ensuring high gloss after thermoforming and having excellent surface quality.

Another aspect of the present invention is to provide an ABS sheet having high gloss and excellent surface quality using the ABS resin composition.

### Technical Solution

In accordance with one aspect of the present invention, an acrylonitrile butadiene styrene (ABS) resin composition includes: a) 50 wt % to 80 wt % of an ABS resin, b) 10 wt % to 30 wt % of a styrene acrylonitrile (SAN) copolymer, and c) 10 wt % to 20 wt % of a rubber resin, wherein the ABS resin is a bulk polymerized ABS resin.

In accordance with another aspect of the present invention, an ABS sheet is manufactured by melt extrusion of an ABS resin composition including: a) 50 wt % to 80 wt % of a bulk polymerized ABS resin, b) 10 wt % to 30 wt % of an SAN copolymer, and c) 10 wt % to 20 wt % of a rubber resin.

### Advantageous Effects

According to the present invention, an acrylonitrile butadiene styrene (ABS) resin composition secures high gloss even in thermoforming by compounding a bulk polymerized ABS resin with a styrene acrylonitrile (SAN) copolymer and rubber particles.

Further, an ABS sheet using the ABS resin composition has excellent surface properties since the sheet includes little gel.

### BEST MODE

The above and other aspects, features, and advantages of the present invention will be become more apparent from the following exemplary embodiments. It should be understood that the present invention is not limited to the following embodiments and may be embodied in different ways, and that the embodiments are provided to provide complete disclosure of the invention and thorough understanding of the invention to those skilled in the art. The scope of the invention is defined only by the claims.

Hereinafter, an acrylonitrile butadiene styrene (ABS) resin composition and an ABS sheet using the same according to the present invention will be described in detail.

An ABS resin composition according to the present invention includes: a) 50 wt % to 80 wt % of an ABS resin, b) 10 wt % to 30 wt % of a styrene acrylonitrile (SAN) copolymer, and c) 10 wt % to 20 wt % of a rubber resin.

ABS Resin

In the present invention, a bulk polymerized ABS resin is used. The bulk polymerized ABS resin provides excellent surface quality for a sheet.

Here, the ABS resin preferably has a melt index of 5 to 10 g/10 min (230° C.). Outside of this range, the ABS resin has excessively high or low viscosity, thus not properly forming a sheet by melt extrusion.

The ABS resin may include 15 to 20 parts by weight of acrylonitrile based on 100 parts by weight of the ABS resin. When the amount of acrylonitrile is less than 15 parts by weight, the strength and weather resistance of the sheet are reduced. When the amount of acrylonitrile is greater than 20 parts by weight, the sheet may not secure high gloss.

The bulk polymerized ABS resin may be present in an amount of 50 wt % to 80 wt % based on the total amount of the ABS resin composition. If the amount of the ABS resin is less than 50 wt %, the number of gels in the sheet increases, causing deterioration in surface quality. If the amount of the ABS resin exceeds 80 wt %, the sheet may not secure high gloss after thermoforming.

SAN Copolymer

The SAN copolymer prevents deterioration in gloss of the sheet in thermoforming due to inherent gloss of the SAN copolymer. The SAN copolymer has excellent compatibility with the bulk polymerized ABS resin in melt mixing.

Like the ABS resin, the SAN copolymer may include 15 to 20 parts by weight of acrylonitrile based on 100 parts by weight of the SAN copolymer.

The SAN copolymer may be present in an amount of 10 wt % to 30 wt % based on the total amount of the ABS resin composition. If the amount of the SAN copolymer is less than 10 wt %, the sheet may not secure high gloss after thermoforming If the amount of the SAN copolymer exceeds 30 wt %, the flexural modulus of the sheet excessively increases.

Rubber Resin

The rubber resin serves to reduce the flexural modulus of the sheet which increases with addition of the SAN copolymer.

The rubber resin may include a methyl methacrylate butadiene styrene (MBS) copolymer.

Here, the MBS copolymer has an average rubber particle size of preferably 0.15 μm or less, more preferably 0.05 to 0.15 μm. When the average rubber particle size of the MBS copolymer is greater than 0.15 μm, the gloss of the sheet is significantly reduced in thermoforming.

The rubber resin may be present in an amount of 10 wt % to 20 wt % based on the total amount of the ABS resin composition. If the amount of the rubber resin is less than 10 wt %, the flexural modulus is not effectively reduced. If the amount of the rubber resin exceeds 20 wt %, the gloss of the sheet is significantly reduced in thermoforming.

Other Additives

In the present invention, the resin composition may further include pigments to impart color.

The pigments may include white, black, yellow, blue, red, and green pigments, which may be used alone or as mixtures.

Specifically, a white pigment may include inorganic particles, such as titanium oxide, calcium carbonate, barium sulfate, and magnesium carbonate, and a black pigment may include carbon black. In addition, yellow, blue, red, and green pigments may include any commercially available pigments.

The pigments may be present in an amount of 0.1 to 30 parts by weight based on 100 parts by weight of the ABS resin composition including the ABS resin, the SAN copolymer, and the rubber resin. If the amount of the pigments is less than 0.1 parts by weight, the sheet does not exhibit an adequate color. If the amount of the pigments exceeds 30 wt %, the surface quality of the sheet can be deteriorated.

In the present invention, the ABS resin composition may further include an antioxidant to prevent yellowing which may occurs in a melt extrusion process.

The antioxidant may include phenolic antioxidants and phosphite antioxidants, which may be used along or as mixtures.

The antioxidant may be present in an amount of 0.01 to 1 part by weight based on 100 parts by weight of the ABS resin composition. When the amount of the antioxidant is less than 0.01 parts by weight, the antioxidant does not function properly. When the amount of the antioxidant is greater than 1 part by weight, the gloss of the ABS resin composition may be reduced.

In addition, the ABS resin composition may further include a variety of additives as long as the additives do not affect physical properties of the composition.

ABS Sheet

The ABS resin composition including the bulk polymerized ABS resin, the SAN copolymer, and the rubber resin according to the present invention may be formed into an ABS sheet by melt extrusion.

Generally, an ABS sheet manufactured using a bulk polymerized ABS resin has reduced gloss in thermoforming, while an ABS sheet manufactured using an emulsion polymerized ABS resin has reduced surface properties. In the present invention, however, the bulk polymerized ABS resin is mixed with the SAN copolymer and the rubber resin, and thus high gloss is secured even in thermoforming and the sheet has less gel on the surface to have excellent surface quality.

Here, the sheet may have a thickness of 50 μm to 1,000 μm depending on melt extrusion conditions.

### EXAMPLES

Hereinafter, characteristics of a silicone adhesive composition according to the present invention will be explained with reference to the following examples. These examples are provided for illustrative purposes only and are not to be in any way construed as limiting the present invention.

Descriptions of details apparent to those skilled in the art will be omitted herein.

1. Preparation of Sample

### Example 1

600 g of a bulk polymerized ABS resin having a melt index of 6 g/10 min (230° C.) and an acrylonitrile content of 17 wt %, 240 g of an SAN copolymer having an acrylonitrile content of 16 wt %, and 160 g of an MB S copolymer having a rubber particle size of 0.08 to 0.1 μm were melt extruded at 240° C. using a biaxial extruder and dried at 80° C. for 4 hours, followed by manufacture of a glossy film having a thickness of 100 μm using an extruder.

### Example 2

A glossy film was manufactured in the same manner as in Example 1 except that 400 g of the ABS resin having the acrylonitrile content of 17 wt % was used.

### Example 3

A glossy film was manufactured in the same manner as in Example 1 except that 80 g of the SAN copolymer having the acrylonitrile content of 16 wt % was used.

### Example 4

A glossy film was manufactured in the same manner as in Example 1 except that 80 g of the MBS copolymer having the rubber particle size of 0.08 to 0.1 μm was used.

### Example 5

A glossy film was manufactured in the same manner as in Example 1 except that an ABS resin having a melt index of 10 g/10 min (230° C.) was used.

### Example 6

A glossy film was manufactured in the same manner as in Example 1 except that an ABS resin having an acrylonitrile content of 20 wt % was used.

### Comparative Example 1

1,000 g of a bulk polymerized ABS resin having a melt index of 6 g/10 min (230° C.) and an acrylonitrile content of 17 wt % was melt extruded at 240° C. using a biaxial extruder and dried at 80° C. for 4 hours, followed by manufacture of a glossy film having a thickness of 100 μm using an extruder.

### Comparative Example 2

750 g of an SAN copolymer having an acrylonitrile content of 30 wt % and 250 g of an MBS copolymer having a rubber particle size of 0.03 ρm were melt extruded at 240° C. using a biaxial extruder and dried at 80° C. for 4 hours, followed by manufacture of a glossy film having a thickness of 100 μm using an extruder.

### Comparative Example 3

1,000 g of an emulsion polymerized ABS resin having a melt index of 4 g/10 min (230° C.) and an acrylonitrile content of 17 wt % was melt extruded at 240° C. using a biaxial extruder and dried at 80° C. for 4 hours, followed by manufacture of a glossy film having a thickness of 100 μm using an extruder.

### Comparative Example 4

600 g of an emulsion polymerized ABS resin having a melt index of 4 g/10 min (230° C.) and an acrylonitrile content of 17 wt %, 240 g of an SAN copolymer having an acrylonitrile content of 16 wt %, and 160 g of an MBS copolymer having a rubber particle size of 0.08 to 0.1 μm were melt extruded at 240° C. using a biaxial extruder and dried at 80° C. for 4 hours, followed by manufacture of a glossy film having a thickness of 100 μnm using an extruder.

### Comparative Example 5

700 g of a bulk polymerized ABS resin having a melt index of 6 g/10 min (230° C.) and an acrylonitrile content of 17 wt % and 300 g of an SAN copolymer having an acrylonitrile content of 30 wt % were melt extruded at 240° C. using a biaxial extruder and dried at 80° C. for 4 hours, followed by manufacture of a glossy film having a thickness of 100 μm using an extruder.

### Comparative Example 6

800 g of a bulk polymerized ABS resin having a melt index of 6 g/10 min (230° C.) and an acrylonitrile content of 17 wt % and 200 g of an MBS copolymer having a rubber particle size of 0.3 μm were melt extruded at 240° C. using a biaxial extruder and dried at 80° C. for 4 hours, followed by manufacture of a glossy film having a thickness of 100 μm using an extruder.

2. Evaluation of Physical Properties

(1) Gel Fraction

Each film manufactured by the extruder was cut into a 10 cm×10 cm piece, followed by measuring the gel fraction on the surface (ea/100 cm²) 5 times and calculating an average value.

(2) Gloss

Gloss of each film was evaluated at an angle of 60° using a glossmeter.

(3) Gloss After Thermoforming

Each film manufactured by the extruder was placed in an oven at 210° C. higher than 150 to 200° C. at which the sheet is actually subjected to thermoforming, followed by taking out the film after 1 minute, 3 minutes, and 5 minutes and measuring the gloss of the film at 60° using a glossmeter.

3. Evaluation Results

Physical properties of the glossy films prepared in the examples and the comparative examples are shown in Table 1.

TABLE 1

| | | | Gloss after thermoforming | | |
|---|---|---|---|---|---|
| | | | After | After | |
| Kind | Gel | Gloss | 1 minute | 3 minutes | After 5 minutes |
| Example 1 | 1 | 84.9 | 84.1 | 53.5 | 36.5 |
| Example 2 | 1.2 | 86.1 | 85.4 | 52.9 | 37.4 |
| Example 3 | 1.6 | 85.1 | 83.9 | 51.7 | 36.2 |
| Example 4 | 1.3 | 84.5 | 83.4 | 53.1 | 36.1 |
| Example 5 | 1.4 | 86.0 | 84.6 | 51.7 | 35.9 |
| Example 6 | 1.5 | 84.9 | 84.2 | 53.2 | 36.7 |
| Comparative | 1.4 | 94.1 | 90.9 | 19.1 | 16.8 |
| Example 1 | | | | | |
| Comparative | More than | 98 | 92 | 33 | 16 |
| Example 2 | 50 | | | | |
| Comparative | More than | 89.4 | 91.4 | 50.1 | 47.3 |
| Example 3 | 50 | | | | |
| Comparative | More than | 91.4 | 90.1 | 63.8 | 56.8 |
| Example 4 | 50 | | | | |
| Comparative | 1.3 | 87.2 | 86.1 | 60.5 | 40.1 |
| Example 5 | | | | | |
| Comparative | 2.0 | 82.4 | 80.5 | 15.5 | 13.1 |
| Example 6 | | | | | |

Referring to Table 1, it can be seen that the films prepared in Example 1 and Comparative Example 4 using the bulk polymerized ABS resin, exhibited excellent surface quality based on a remarkably low gel fraction per 100 cm².

However, the film prepared in Comparative Example 1 using the bulk polymerized ABS resin only exhibited drastically reduced gloss after thermoforming as compared with the film of Example 1 including the SAN copolymer and the MBS copolymer.

The films of Comparative Examples 3 and 4 including the emulsion polymerized ABS resin exhibited excellent gloss after thermoforming, but had poor surface quality based on a gel fraction greater than 50 per 100 cm².

Further, the film of Comparative Example 2 not using the ABS resin was inadequate in terms of surface quality and gloss after thermoforming.

The film of Comparative Example 5 not using the MBS copolymer maintained proper gloss after thermoforming and had a low gel fraction, but the film was not proper for use due to serious breakage and remarkably low processibility.

The film of Comparative Example 6 not using the SAN copolymer had a relatively high gel fraction and exhibited inappropriate surface quality and gloss.

Although some embodiments have been disclosed herein, it will be apparent to those skilled in the art that these embodiments are given by way of illustration only, and that various modifications, changes, alterations, and equivalent embodiments can be made without departing from the spirit and scope of the invention. The scope of the invention should be limited only by the accompanying claims.

1. An acrylonitrile butadiene styrene (ABS) resin composition comprising:
a) 50 wt % to 80 wt % of an ABS resin;
b) 10 wt % to 30 wt % of a styrene acrylonitrile (SAN) copolymer; and
c) 10 wt % to 20 wt % of a rubber resin,
wherein the ABS resin is a bulk polymerized ABS resin.

2. The ABS resin composition according to claim 1, wherein the ABS resin has a melt index of 5 to 10 g/10 min (230° C.).

3. The ABS resin composition according to claim 1, wherein the ABS resin comprises 15 to 20 parts by weight of acrylonitrile based on 100 parts by weight of the ABS resin.

4. The ABS resin composition according to claim 1, wherein the SAN copolymer comprises 15 to 20 parts by weight of acrylonitrile based on 100 parts by weight of the SAN copolymer.

5. The ABS resin composition according to claim 1, wherein the rubber resin comprises a methyl methacrylate butadiene styrene (MBS) copolymer.

6. The ABS resin composition according to claim 5, wherein the MBS copolymer has an average rubber particle size of 0.05 μm to 0.15 μm.

7. The ABS resin composition according to claim 1, wherein the ABS resin composition further comprises 0.1 to 30 parts by weight of a pigment based on 100 parts by weight of the ABS resin composition.

8. The ABS resin composition according to claim 7, wherein the ABS resin composition further comprises 0.01 to 1 part by weight of an antioxidant based on 100 parts by weight of the ABS resin composition.

9. An acrylonitrile butadiene styrene (ABS) sheet manufactured by melt extrusion of an ABS resin composition comprising a) 50 wt % to 80 wt % of a bulk polymerized ABS resin, b) 10 wt % to 30 wt % of a styrene acrylonitrile (SAN) copolymer, and c) 10 wt % to 20 wt % of a rubber resin.

10. The ABS sheet according to claim 9, wherein the sheet has a thickness of 50 μm to 1,000 μm.
